(19) United States
(12) Patent Application Publication
(10) Pub. No.: US 2016/0091753 A1
(43) Pub. Date: Mar. 31, 2016

(54) LIQUID CRYSTAL DISPLAY PANEL

(71) Applicant: Samsung Display Co., Ltd., Yongin-city (KR)

(72) Inventors: Yi-Seop SHIM, Yongin-city (KR); Chang-Soon JANG, Yongin-city (KR); Chul HUH, Yongin-city (KR)

(21) Appl. No.: 14/730,955

(22) Filed: Jun. 4, 2015

(30) Foreign Application Priority Data
Sep. 26, 2014 (KR) 10-2014-0129201

(51) Int. Cl. G02F 1/1335; G02F 1/1339

(52) U.S. Cl. CPC G02F 1/133514; G02F 1/13394; G02F 2001/133519

(57) ABSTRACT

A liquid crystal display panel including an array substrate including pixel areas, an opposite substrate facing the array substrate, the opposite substrate including a first base substrate, color filters disposed on the first base substrate, the color filters facing the array substrate and corresponding to the pixel areas, and a cell gap adjustment pattern disposed on at least one of the color filters, and a liquid crystal layer disposed between the array substrate and the opposite substrate.

### CROSS-REFERENCE TO RELATED APPLICATION

This application claims priority from and the benefit of Korean Patent Application No. 10-2014-0129201, filed on Sep. 26, 2014, which is hereby incorporated by reference for all purposes as if fully set forth herein.

### BACKGROUND

1. Field

Exemplary embodiments of the present invention relate to a liquid crystal display device, and more particularly, to a liquid crystal display device with improved display quality.

2. Discussion of the Background

A liquid crystal display panel may include an array substrate in which a pixel electrode and a pixel including a thin film transistor are arranged in a matrix format, an opposite substrate that faces the array substrate and includes color filters, and a liquid crystal layer arranged between the array substrate and the opposite substrate. In the liquid crystal display panel, an image may be formed by controlling light transmitted through liquid crystal molecules of each pixel.

The color filters may be one of a red, green and blue color filter, and each color filter may be disposed to correspond to each pixel of the array substrate.

The color filters may have different thicknesses depending on their colors to adjust color coordinates of white light for a display screen, or to adjust light transmittance of the liquid crystal layer. When the color filters have different thicknesses, a color purity of a color from a thicker color filter may be expressed more strongly than a color from a thinner color filter, and thus an image displayed in the liquid crystal display panel may have a color tone resembling the color of the thicker color filter. A blue color filter may have the thickest color filter, and thus an image embodied in the liquid crystal display panel may be recognized in a blue tone.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a liquid crystal display panel with improved display quality.

Additional aspects will be set forth in the detailed description which follows, and, in part, will be apparent from the disclosure, or may be learned by practice of the inventive concept.

According to an exemplary embodiment of the present invention, a liquid crystal display panel includes an array substrate including pixel areas, an opposite substrate facing the array substrate and including a first base substrate, color filters disposed on the first base substrate, the color filters facing the array substrate and corresponding to the pixel areas, and a cell gap adjustment pattern disposed on at least one of the color filters, and a liquid crystal layer disposed between the array substrate and the opposite substrate.

The cell gap adjustment pattern may include an organic material configured to transmit light.

The cell gap adjustment pattern may include one of an acrylic organic compound, polytetrafluoroethylene (PTFE), benzocyclobutene (BCB), Cytop®, and perfluorocyclobutene (PFCB).

A thickness of the cell gap adjustment pattern may be in a range of 0.5 μm to 1.5 μm.

Each of the color filter may have substantially the same thickness.

Each of the color filter may be one of a red color filter, a green color filter, and a blue color filter, and the cell gap adjustment pattern may be disposed on the blue color filter.

The liquid crystal display panel may further include a common electrode disposed on the color filters, and an overcoat layer disposed between the color filters and the common electrode.

The cell gap adjustment pattern may be disposed on the common electrode.

The cell gap adjustment pattern may be disposed between the blue color filter and the overcoat layer.

According to an exemplary embodiment of the present invention, a liquid crystal display panel may include an array substrate including pixel areas, an opposite substrate including color filters corresponding to the pixel areas, each color filter having substantially the same thickness, and a cell gap adjustment pattern disposed on at least one of the color filters and facing the array substrate, and a liquid crystal layer disposed between the array substrate and the opposite substrate, in which a first cell gap corresponding to a distance between the array substrate and the opposite substrate in a first pixel area comprising the cell gap adjustment pattern is smaller than a second cell gap corresponding to a distance between the array substrate and the opposite substrate in a second pixel area without the cell gap adjustment pattern.

The first cell gap may be in a range of 0.5 μm to 1.5 μm smaller than the second cell gap.

According to an exemplary embodiment of the present invention, a liquid crystal display panel may include an array substrate including pixel areas, an opposite substrate including color filters corresponding to the pixel areas, each color filter having substantially the same thickness, a first cell gap adjustment pattern disposed on a first color filter of the color filters, and a second cell gap adjustment pattern disposed on a second color filter of the color filters, and a liquid crystal layer disposed between the array substrate and the opposite substrate, in which a thickness of the first cell gap adjustment pattern is different from a thickness of the second cell gap adjustment pattern.

The first and second cell gap adjustment patterns may be disposed on the common electrode.

The first and second cell gap adjustment patterns may be disposed between the color filters and the overcoat layer.

The liquid crystal display panel may further include a column spacer disposed between the array substrate and the opposite substrate, in which a distance between the array substrate and the opposite substrate may be in a range of 1.5 μm to 4 μm.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic view of a liquid crystal display device according to an exemplary embodiment of the present invention.

FIG. 2 is a plane view of a liquid crystal display panel according to an exemplary embodiment of the present invention.

FIG. 3 is a cross-sectional view along line I-I′ of FIG. 2.

FIG. 4 is a cross-sectional view along line II-IF of FIG. 2.

FIG. 5 is a cross-sectional view of a liquid crystal display panel according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

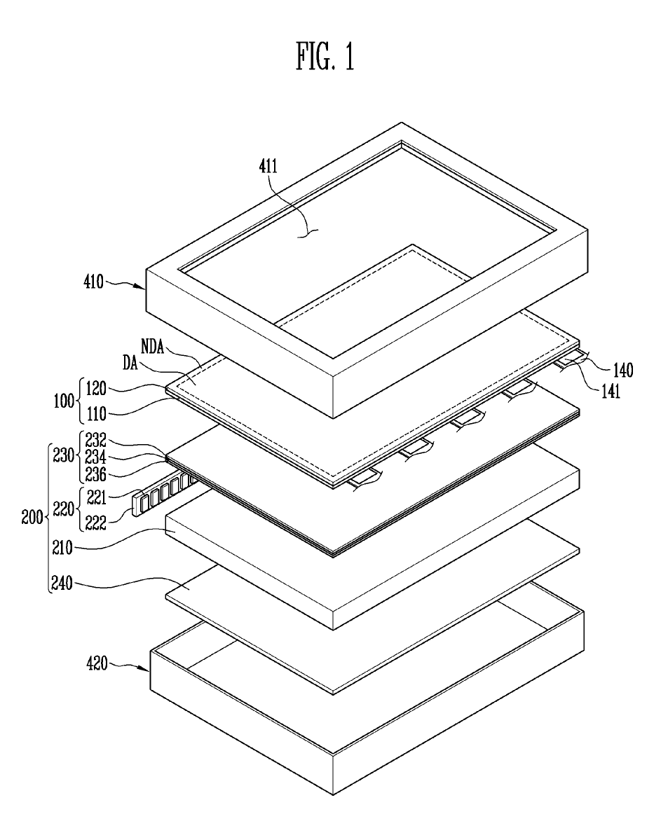

FIG. 1 is a schematic view illustrating a liquid crystal display device according to an exemplary embodiment of the present invention.

Referring to FIG. 1, the liquid crystal display device includes a liquid crystal display panel 100, a backlight unit 200, an upper cover 410, and a lower cover 420.

The liquid crystal display panel 100 may be a rectangular panel including a display area DA for displaying an image and a non-display area NDA arranged near the display area DA. The liquid crystal display panel 100 may further include an array substrate 110, an opposite substrate 120 facing the array substrate 110, and a liquid crystal layer (not shown) disposed between the array substrate 110 and the opposite substrate 120. A polarizing film (not shown) may be disposed on both surfaces of the liquid crystal display panel 100. That is, the polarizing film may be disposed on an external surface of the array substrate 110 and the opposite substrate 120.

On the display area DA of the array substrate 110, pixels (not shown) may be arranged in a matrix format. Each pixel may include sub-pixels having a different color. Each sub-pixel may have one of red, green, blue, cyan, magenta, and yellow colors. Therefore, light emitted from each of these sub-pixels may have one of red, green, blue, cyan, magenta, and yellow color. Each pixel may have a gate line (not shown), data line (not shown) insulated from and intersecting the gate line, and pixel electrode (not shown). Each pixel may further include a thin-film transistor (not shown) electrically connected to the gate line, the data line, and to the corresponding pixel electrode. The thin-film transistor may switch a driving signal provided to the corresponding pixel electrode.

The non-display area NDA of the array substrate 110 may include a bag pattern (not shown) that bonds the array substrate 110 and the opposite substrate 120.

The opposite substrate 120 may include a color filter (not shown) configured to implement a predetermined color with light emitted from the backlight unit 200, and a common electrode (not shown) formed on the color filter and facing the pixel electrode (not shown). The color filter may have one of red, green, blue, cyan, magenta, and yellow color, and may be formed by a deposition or coating process. According to an exemplary embodiment of the present invention, the color filter may be disposed on the array substrate 110.

The pixel electrode and the common electrode may apply a voltage to the liquid crystal layer to arrange the liquid crystal layer in a certain direction. In order to display an image, the liquid crystal display panel 100 may adjust transmittance of light emitted from the backlight unit 200 by applying a voltage from the pixel electrode and the common electrode to the liquid crystal layer, to change the arrangement direction of the liquid crystal layer.

In the non-display area NDA, a signal input pad (not shown) may be disposed on an external surface of one of the array substrate 110 and the opposite substrate 120. The signal input pad may be connected to a flexible circuit board 140 where a driver IC 141 is mounted, and the flexible circuit board 140 may be connected to an external circuit module (not shown). The driver IC 141 may receive various control signals from the external circuit module, and output a driving signal that drives the liquid crystal display panel 100 to the thin-film transistor.

The backlight unit 200 may be arranged on an opposite side of the liquid crystal panel 100 to which an image is displayed. The backlight unit 200 may include a light guide panel 210, an optical unit 220 including light sources, an optical member 230, and a reflective sheet 240.

The light guide panel 210 may be disposed under the liquid crystal display panel 100, guide the light from the light source unit 220, and output the light to the liquid crystal display panel 100 direction. The light guide panel 210 may at least overlap the display area DA of the liquid crystal display panel 100. The light guide panel 210 may include an output surface that outputs light, a lower surface opposite to the output surface, and side surfaces that connect the output surface to the lower surface. At least one of the side surfaces may be an incidence surface facing the light source unit 220 and through which light from the light source unit 220 enters. A side surface opposite to the incidence surface may be a light surface that reflects the light.

The light source unit 220 may include light sources 221. For example, light-emitting diodes may be mounted on a printed circuit board (PCB) 222.

According to an exemplary embodiment of the present invention, the light sources 221 may output light of the same color. For example, the light sources 221 may output white light.

According to an exemplary embodiment of the present invention, the light sources 221 may output light of different colors. For example, some of the light sources 221 may output red light, while other light sources 221 output green light or blue light.

The light source unit 220 may be arranged to face at least one of the side surfaces of the light guide panel 210, and provide light used to display an image through the light guide panel 210.

The optical member 230 may be disposed between the light guide panel 210 and the liquid crystal display panel 100. The optical member 230 may control light provided from the light source unit 220, and output the light through the light guide panel 210. The optical member 230 may include a deposited diffusion sheet 236, a prism sheet 234, and a protection sheet 232, sequentially.

The diffusion sheet 236 may diffuse light output from the light guide panel 210. The prism sheet 234 may collect the light diffused from the diffusion sheet 236 in a direction perpendicular to a plane of the liquid crystal display panel 100. Most of the light that penetrates the prism sheet 234 may enter the liquid crystal display panel 100 perpendicularly. The protection sheet 232 may be disposed on the prism sheet 234 to protect the prism sheet 234 from an external impact.

According to an exemplary embodiment of the present invention, at least one of the diffusion sheet 236, prism sheet 234, and protection sheet 232 of the optical member 230 may include overlapping sheets. One of the diffusion sheet 236, prism sheet 234, and protection sheet 232 may be omitted from the optical member 230.

The reflective sheet 240 may be disposed under the light guide panel 210 and reflect the light that travels to a direction other than to the liquid crystal display panel 100 in order to redirect the leaked light to the liquid crystal display panel 100. The reflective sheet 240 may include a material that reflects light. The reflective sheet 240 may be disposed on the lower cover 420, and reflect light generated from the light source unit 220. As a result, the reflective sheet 240 may increase an amount of light provided towards the liquid crystal display panel 100.

According to an exemplary embodiment of the present invention, the light source unit 220 may be arranged to provide light towards a lower surface direction of the light guide panel 210. According to an exemplary embodiment of the present invention, the light guide panel 210 may be omitted from the backlight unit 200 and the light source unit 220 may be arranged under the liquid crystal display panel 100, so that light output from the light source unit 220 may be directly provided to the liquid crystal display panel 100.

The upper cover 410 may be arranged above the liquid crystal display panel 100. The upper cover 410 may include a display window 411 that exposes the display area DA of the liquid crystal display panel 100. The upper cover 410 may be combined with the lower cover 420 and support the liquid crystal display panel 100.

The lower cover 420 may be arranged under the backlight unit 200. The lower cover 420 may include space that accommodates the liquid crystal display panel 100 and the backlight unit 200. The lower cover 420 may be combined with the upper cover 410 and include and support the liquid crystal display panel 100 and the backlight unit 200 in its internal space.

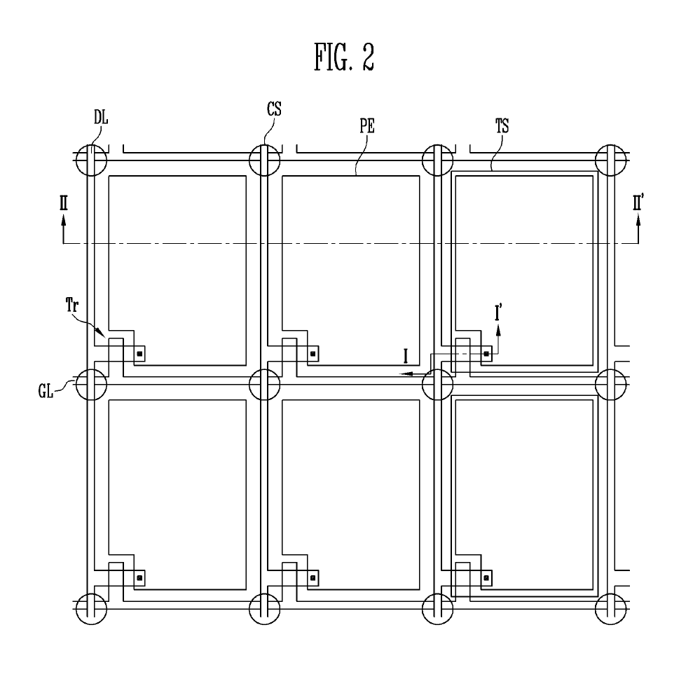

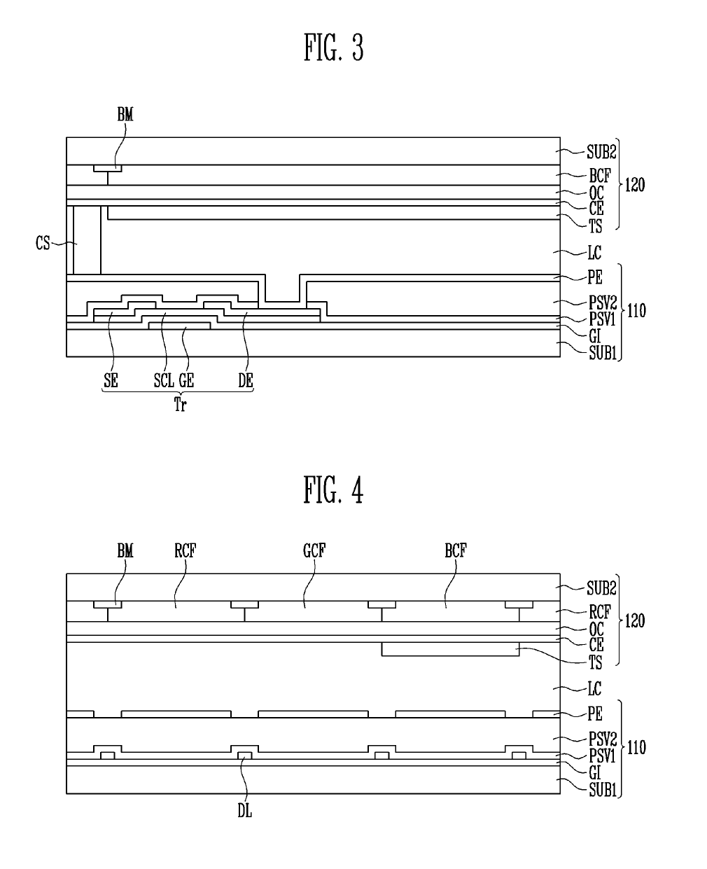

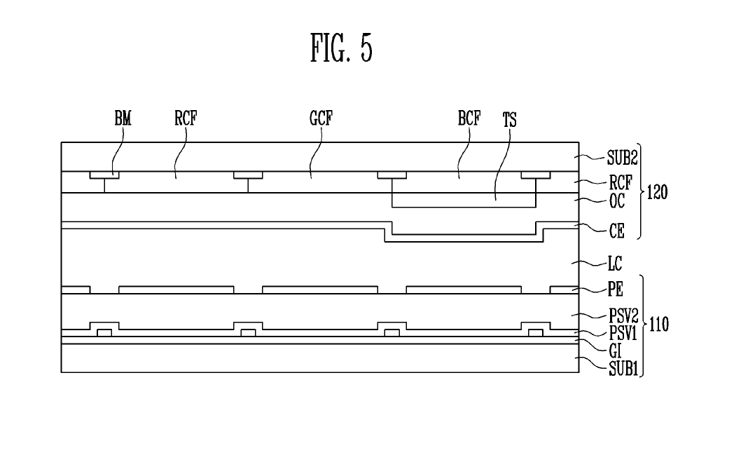

FIG. 2 is a plane view of a liquid crystal display panel illustrated in FIG. 1, FIG. 3 is a cross-sectional view along line I-I′ of FIG. 2, and FIG. 4 is a cross-sectional view along line II-II′ of FIG. 2.

Referring to FIG. 2, FIG. 3, and FIG. 4, the liquid crystal display panel may include an array substrate 110, an opposite substrate 120 facing the array substrate 110, and a liquid crystal layer LC arranged between the array substrate 110 and the opposite substrate 120.

The array substrate 110 may be a thin-film transistor array substrate that includes thin-film transistors Tr for driving liquid crystal molecules of the liquid crystal layer LC. The opposite substrate 120 may be a color filter substrate facing the array substrate 110.

When an electric field is applied between the array substrate 110 and the opposite substrate 120, the liquid crystal molecules may rotate in a certain direction between the array substrate 110 and the opposite substrate 120. As the liquid crystal molecules rotate, the liquid crystal display panel 100 may transmit or block light. The applied electric field may also change the orientation of the liquid crystal molecules.

The array substrate 110 may include pixel areas arranged in a matrix format. Each pixel area may be one of a red pixel area, green pixel area, and blue pixel area. The red pixel area, green pixel area, and blue pixel area may constitute one pixel.

The array substrate 110 may further include a first base substrate SUB1, a thin-film transistor Tr arranged on the first base substrate SUB1, and a pixel electrode PE connected to the thin-film transistor Tr.

The first base substrate SUB1 may include a transparent insulating material that transmits light. The first base substrate SUB1 may be a rigid type or a flexible type substrate. The rigid type substrate may include a glass substrate, quartz substrate, glass ceramic substrate, or crystalline glass substrate. The flexible type substrate may include a film substrate or plastic substrate that includes high molecular organic materials. The first base substrate SUB1 may include a material that has resistance (or thermo-resistance) against high processing temperatures during a manufacturing process.

On the first base substrate SUB1, gate lines GL may be disposed and extend in one direction and data lines DL may be disposed and extend in a direction intersecting the gate lines GL. For example, the gate lines GL may extend in a vertical or horizontal direction between the pixel areas.

The thin-film transistor Tr and a pixel electrode PE may be disposed on the pixel areas.

The thin-film transistor Tr is connected to the gate line GL and data line DL, and may transmit a driving signal to the pixel electrode PE.

The thin-film transistor Tr may include a gate electrode GE, a semiconductor layer SCL, a source electrode SE, and a drain electrode DE. The gate electrode GE may have a shape protruding from the gate line GL. Furthermore, the gate electrode GE may be disposed on a portion of the gate line GL. The semiconductor layer SCL may overlap the gate electrode GE having a gate insulator film GI therebetween. The source electrode SE may be diverged from the data line DL such that a portion of the source electrode SE overlaps the gate line GL. The drain electrode DE may be spaced apart from the source electrode SE having the semiconductor layer SM therebetween, and a portion of the drain electrode DE may overlap the gate line GL.

According to an exemplary embodiment of the present invention, the thin-film transistor Tr may be a thin-film transistor having a top gate structure in which the gate electrode GE is located above the semiconductor layer SCL.

A first protection film PSV1 may be disposed on the first base substrate SUB1 where the thin-film transistor Tr is disposed. The first protection film PSV1 may cover the thin-film transistor Tr. The first protection film PSV1 may include silicone nitride (SiNx) and/or silicone oxide (SiOx). For example, the first protection film PSV1 may include a silicone nitride film, and/or a silicone oxide film arranged on the silicon nitride film.

A second protection film PSV2 may be disposed on the first protection film PSV1. The second protection film PSV2 may include a transparent organic insulating material, and planarize a surface of the array substrate 110. The second protection film PSV2 may include a contact hole that exposes a portion of the drain electrode DE.

A pixel electrode PE may be disposed on the second protection film PSV2. The pixel electrode PE may be connected to the drain electrode DE through the contact hole. The pixel electrode PE may include a transparent conductive oxide, such as indium tin oxide (ITO) and/or indium zinc oxide (IZO).

The opposite substrate 120 may include a second base substrate SUB2, black matrixes BM, color filters RCF, GCF, and BCF, an overcoat layer OC, and a common electrode CE.

The back matrixes BM may be disposed on a surface of the second base substrate SUB2 facing the array substrate 110. The black matrixes BM may be disposed on areas that correspond to areas where the data lines DL are disposed, and prevent light leakage. The black matrixes BM may include one of chrome Cr, and a carbon type non-transmissive material.

The color filters RCF, GCF, and BCF may be disposed on areas between the black matrixes BM. That is, the color filters RCF, GCF, and BCF may be disposed on the pixel area. The color filters RCF, GCF, and BCF may be one of a red color filter RCF, a green color filer GCF, and a blue color filter BCF. That is, the color of light output from the pixel areas may be determined by the color filters RCF, GCF, and BCF.

The thicknesses of the color filters RCF, GCF, and BCF may be substantially the same. Accordingly, the liquid crystal display panel according to the present exemplary embodiment may prevent the color purity of a certain color being expressed more strongly than the other colors in the liquid crystal display panel.

The overcoat layer OC may be disposed to cover the color filters RCF, GCF, and BCF. The overcoat layer OC may remove a surface difference by the color filters RCF, GCF, and BCF, and planarize the surface of the opposite substrate 120.

The common electrode CE may be disposed on the overcoat layer OC. The common electrode CE may include the same material as the pixel electrode PE, such as ITO and IZO.

A column spacer CS may be disposed between the array substrate 110 and the opposite substrate 120. The column spacer CS may be disposed in an area where the data line DL and the gate line GL intersects each other. The thickness of the column spacer CS may be in a range of 1.5 μm to 4 μm.

The column spacer CS may be formed by depositing a photosensitive resin on a surface of one of the array substrate 110 and the opposite substrate 120, exposing to light and then developing the photosensitive resin. The column spacer CS may maintain a certain distance between the array substrate 110 and the opposite substrate 120 from an external pressure.

A cell gap adjustment pattern TS configured to adjust a distance between the array substrate 110 and the opposite substrate 120 (hereinafter referred to as “cell gap”) may be disposed on a portion of the common electrode CE that corresponds to a pixel area of each color.

According to the present exemplary embodiment, the cell gap adjustment pattern TS may be disposed on the common electrode CE which corresponds to the blue pixel area. The cell gap adjustment pattern TS may make a cell gap of the red pixel area and the green pixel area different from a cell gap of the blue pixel area. That is, the cell gap adjustment pattern TS may make the cell gap of the blue pixel area smaller than the cell gaps of the red pixel area and the green pixel area.

According to an exemplary embodiment of the present invention, cell gap adjustment patterns TS may be disposed on portions of the common electrode CE that correspond to any one or more of the red, green, and blue pixel areas. The cell gap adjustment pattern TS corresponding to one of the color pixel area may have a thickness different from the cell gap adjustment pattern TS corresponding to another color pixel area.

A thickness of the cell gap adjustment pattern TS may be in the range of 0.5 μm to 1.5 μm. Therefore, according to the present exemplary embodiment, the cell gap of the blue pixel area may be 0.5 μm to 1.5 μm smaller than the cell gap of the red pixel area and the green pixel area.

The cell gap adjustment pattern TS may include an organic material that transmits light. For example, the cell gap adjustment pattern TS may include one of an acrylic organic compound, polytetrafluoroethylene (PTFE), benzocyclobutene (BCB), Cytop®, and perfluorocyclobutene (PFCB).

Since the thicknesses of the color filters RCF, GCF, and BCF are substantially the same, the liquid crystal display panel may prevent a color purity of a certain color from being expressed more strongly than the other colors. The liquid crystal display panel may embody a multi cell gap by the cell gap adjustment pattern TS, and may adjust an optical transmittance of the liquid crystal layer for each pixel. Therefore, the liquid crystal display panel may have improved display quality.

FIG. 5 is a cross sectional view of a liquid crystal display panel according to an exemplary embodiment of the present invention. The liquid crystal display panel illustrated in FIG. 5 includes elements that are substantially similar to the liquid crystal display panel illustrated with reference to FIGS. 1 to 4, and repeated description of the substantially similar elements and operations will be omitted.

Referring to FIG. 5, a liquid crystal display panel may include an array substrate 110, an opposite substrate 120 facing the array substrate 110, and a liquid crystal layer LC disposed between the array substrate 110 and the opposite substrate 120.

The array substrate 110 may be a thin-film transistor array substrate where thin-film transistors Tr for driving liquid crystal molecules of the liquid crystal layer LC are formed. The opposite substrate 120 may be a color filter substrate facing the array substrate 110.

The opposite substrate 120 may include a second base substrate SUB2, black matrixes BM, color filters RCF, GCF, and BCF, a cell gap adjustment pattern TS, an overcoat layer OC, and a common electrode CE.

The black matrixes BM may be disposed on a surface of the second base substrate SUB 2 facing the array substrate 110, and the color filters RCF, GCF, and BCF may be disposed between the black matrixes BM. Thicknesses of each of the color filters RCF, GCF, and BCF may be substantially the same.

The cell gap adjustment pattern TS may be disposed on one of the color filters RCF, GCF, and BCF, and the overcoat layer OC may be disposed to cover the color filters RCF, GCF, BCF, and the cell gap adjustment pattern TS. That is, the cell gap adjustment pattern TS may be disposed between one of the color filter and the overcoat layer OC.

According to the present exemplary embodiment, the cell gap adjustment pattern TS may be arranged between the blue color filter BCF and the overcoat layer OC. Therefore, the cell gap adjustment pattern TS may make the cell gap of the red pixel area and the green pixel area different from the cell gap of the blue pixel area. For example, the cell gap adjustment pattern TS may make the cell gap of the red pixel area and the green pixel area smaller than the cell gap of the blue pixel area.

According to an exemplary embodiment of the present invention, cell gap adjustment patterns TS may be disposed on color filters that correspond to any one of the red, green, and blue pixel areas. The cell gap adjustment pattern TS corresponding to one of the color pixel area may have a thickness different from the cell gap adjustment pattern TS corresponding to another color pixel area.

The liquid crystal display panel according to exemplary embodiments of the present invention has a cell gap adjustment pattern disposed on a color filter of a certain color, and thus the cell gaps of pixel areas may be varied even when the thickness of the color filters are the same. Therefore, an image embodied in the liquid crystal display panel may be prevented from being recognized in a certain color. That is, the display quality of the liquid crystal display panel may be improved.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A liquid crystal display panel, comprising:
an array substrate comprising pixel areas;
an opposite substrate facing the array substrate, the opposite substrate comprising:
a first base substrate;
color filters disposed on the first base substrate, the color filters facing the array substrate and corresponding to the pixel areas; and
a cell gap adjustment pattern disposed on at least one of the color filters; and
a liquid crystal layer disposed between the array substrate and the opposite substrate.

2. The liquid crystal display panel of claim 1, wherein the cell gap adjustment pattern comprises an organic material configured to transmit light.

3. The liquid crystal display panel of claim 2, wherein the cell gap adjustment pattern comprises one of an acrylic organic compound, polytetrafluoroethylene (PTFE), benzocyclobutene (BCB), Cytop®, and perfluorocyclobutene (PFCB).

4. The liquid crystal display panel of claim 3, wherein a thickness of the cell gap adjustment pattern is in a range of 0.5 μm to 1.5 μm.

5. The liquid crystal display panel of claim 4, wherein each of the color filters have substantially the same thickness.

6. The liquid crystal display panel of claim 5, wherein:
each of the color filters is one of a red color filter, a green color filter, and a blue color filter; and
the cell gap adjustment pattern is disposed on the blue color filter.

7. The liquid crystal display panel of claim 6, further comprising:
a common electrode disposed on the color filters; and
an overcoat layer disposed between the color filters and the common electrode.

8. The liquid crystal display panel of claim 7, wherein the cell gap adjustment pattern is disposed on the common electrode.

9. The liquid crystal display panel of claim 7, wherein the cell gap adjustment pattern is disposed between the blue color filter and the overcoat layer.

10. A liquid crystal display panel, comprising:
an array substrate comprising pixel areas;
an opposite substrate comprising:
color filters corresponding to the pixel areas, each color filter having substantially the same thickness; and
a cell gap adjustment pattern disposed on at least one of the color filters and facing the array substrate; and
a liquid crystal layer disposed between the array substrate and the opposite substrate,
wherein:
a first cell gap corresponding to a distance between the array substrate and the opposite substrate in a first pixel area comprising the cell gap adjustment pattern is smaller than a second cell gap corresponding to a distance between the array substrate and the opposite substrate in a second pixel area without the cell gap adjustment pattern.

11. The liquid crystal display panel of claim 10, wherein the first cell gap is in a range of 0.5 μm to 1.5 μm smaller than the second cell gap.

12. The liquid crystal display panel of claim 11, wherein the cell gap adjustment pattern comprises an organic material configured to transmit light.

13. The liquid crystal display panel of claim 12, wherein the cell gap adjustment pattern comprises one of an acrylic organic compound, polytetrafluoroethylene (PTFE), benzocyclobutene (BCB), Cytop®, and perfluorocyclobutene (PFCB).

14. The liquid crystal display panel of claim 10, wherein:
each of the color filters is one of a red color filter, a green color filter, and a blue color filter; and
the cell gap adjustment pattern is disposed on the blue color filter.

15. A liquid crystal display panel, comprising:
an array substrate comprising pixel areas;
an opposite substrate comprising:
color filters corresponding to the pixel areas, each color filter having substantially the same thickness;
a first cell gap adjustment pattern disposed on a first color filter of the color filters; and
a second cell gap adjustment pattern disposed on a second color filter of the color filters; and
a liquid crystal layer disposed between the array substrate and the opposite substrate,
wherein a thickness of the first cell gap adjustment pattern is different from a thickness of the second cell gap adjustment pattern.

16. The liquid crystal display panel of claim 15, further comprising:
a common electrode disposed on the color filters; and
an overcoat layer disposed between the color filters and the common electrode.

17. The liquid crystal display panel of claim 16, wherein the first and second cell gap adjustment patterns are disposed on the common electrode.

18. The liquid crystal display panel of claim 16, wherein the first and second cell gap adjustment patterns are disposed between the color filters and the overcoat layer.

19. The liquid crystal display panel of claim 16, further comprising a column spacer disposed between the array substrate and the opposite substrate,
wherein a distance between the array substrate and the opposite substrate is in a range of 1.5 μm to 4 μm.

20. The liquid crystal display panel of claim 15, wherein each of the first and second cell gap adjustment patterns comprise one of an acrylic organic compound, polytetrafluoroethylene (PTFE), benzocyclobutene (BCB), Cytop®, and perfluorocyclobutene (PFCB).
